(19) United States
(12) Patent Application Publication
(10) Pub. No.: US 2023/0036125 A1
(43) Pub. Date: Feb. 2, 2023

(54) DEPLOYMENT MECHANSIM FOR A BARIATRIC RAMP

(71) Applicant: SG Technical Systems Ltd, Market Weighton (GB)

(72) Inventor: Simon CHACKSFIELD, Market Weighton (GB)

(73) Assignee: SG Technical Systems Ltd, Market Weighton (GB)

(21) Appl. No.: 17/815,355

(22) Filed: Jul. 27, 2022

(30) Foreign Application Priority Data
Jul. 28, 2021 (GB) 2110827.9

(51) Int. Cl. E04F 11/00

(52) U.S. Cl. CPC E04F 11/002; E04F 2011/005

(57) ABSTRACT

A deployment mechanism for a bariatric ramp which has a drive motor pivotally secured to one side of the ramp platform. The deployment mechanism includes a lever located in a housing on the opposing side of the platform ramp. One end of the lever being connected to a platform pivot bar and the other end being connected to a traction gas spring secured within the housing. The spring mechanism comprises a drive shaft having a first and second torque levers located either end of the drive shaft. The drive shaft being rotatable as the platform is deployed such that the torque levers move between a first position whereby only the first torque lever acts on the spring and to a second position whereby neither first nor second torque levers act on the spring and to a third position whereby only the second torque lever acts on the spring.

### FIELD OF THE INVENTION

The present invention relates to an improved deployment system for a bariatric ramp.

### BACKGROUND TO THE INVENTION

Common bariatric ramps, such as for example the EasyLoad™ ramp manufactured and supplied by the applicant, are driven by a geared electric motor. The motor is controlled by a dedicated controller. One of the controller's functions is to monitor the amps drawn by the motor and if the amperage exceeds approximately 8 A the controller acts to turn the motor off.

The motor remains turned off until an operator's releases the open or close switch. When the switch is re-pressed the controller will act to activate the ramp as normal.

The system described is used for obstacle detection. If an object is placed on a moving ramp platform the weight increase will cause the motor current to exceed 8 A and, as a consequence, the controller will act to stop the motor. Similarly, if a person is standing on the platform and their weight will cause the controller to stop the ramp motor.

In the event of an electrical failure the ramp platform can be deployed and stowed manually using a handle (typically an elastic cord). To reduce the force required to manually lift the ramp platform the geared motor is specifically designed to have a low back drive force. This combination provides a high output torque with low output speed so the geared motor can be back driven with relative ease. The low back drive force means that the ramp platform can be easily manually deployed.

Whilst the ramp deployment mechanism described works very well for bariatric ramps within a conventional size range, the mechanism becomes impractical and fails to work for larger, wider ramps, for example a bariatric ramp that is currently being developed by the Applicant which is designed to support a heavier stretcher and which, as a result, is approximately 50% heavier than conventional ramps.

Heavier ramps require a more powerful geared motor which causes other problems when it comes to the manual deployment mechanism. A higher powered motor draws a higher current so will not work with the standard controllers. Furthermore, it takes a greater force to back drive the larger geared motor. If the same motor is used, coupled to a higher ratio gearbox, the current draw can be kept to below the desired limit but the back-drive force will be higher and the ramp will deploy slower as a result. Ramp deployment speed is a significant factor that is taken into account by ambulance operators as operational speed is essential in emergency situations.

Moreover, full drive torque is applied to one side of the platform only, and the increased torque load (which may be 50% higher than standard) risks fatigue cracking along that side.

There is also a commercial necessity for the platform to be manually deployed without any increase in the deployment force required to be applied by the operator compared to the standard ramp. Without further adaptation, this would be impossible due to the increased motor size or gearbox ratio and the increased weight of the ramp.

The present invention seeks to overcome the aforementioned issues by providing a ramp deployment mechanism that applies a torque to effectively compensate for the additional weight of the ramp platform. Further, the mechanism is designed to apply a torque that progressively increases from around zero as the platform lowers from vertical dead centre towards the fully deployed or stowed orientation to compensate for the additional weight.

These features allow use of a motor and controller that is used for conventionally sized ramps and maintains the manual deployment force at the same low level as a standard ramp.

The torque applied by the mechanism should be sufficient to reduce the torque required from the drive motor to a level approximately the same as for standard ramp. Typically, the torque applied to the mechanism should be approximately equal to 50% of the torque of a standard drive motor.

### STATEMENTS OF INVENTION

According to a first aspect of the invention, there is provided a deployment mechanism for a bariatric ramp having a drive motor pivotally secured to one side of the ramp platform, the deployment mechanism including a lever located in a housing on the opposing side of the platform ramp, one end of the lever being connected to a platform pivot bar and the other end being connected to a torsion spring mechanism secured within the housing; wherein the spring mechanism comprises a drive shaft having a first and second torque levers located either end of the drive shaft, the drive shaft being rotatable as the platform is deployed such that the torque levers move between a first position whereby only the first torque lever acts on the spring and to a second position whereby neither first nor second torque levers act on the spring and to a third position whereby only the second torque lever acts on the spring.

Preferably, the drive shaft includes a spring with inner and outer straightened legs and respective ends of the spring.

Preferably, the spring mechanism further comprises a fixed bar secured at one end to housing and extending generally parallel to the drive shaft.

Preferably, a gap is provided between the drive shaft and the fixed bar which is sufficient to allow each torque lever to pass underneath during rotation of the drive shaft.

Preferably, each spring leg extends outwardly from the spring coil beyond the gap between the fixed bar and the drive shaft.

Preferably, activation of a torque lever is enabled when a leg of the spring abuts against the fixed bar.

Preferably, the lever is located opposite the drive motor pivot point.

Preferably, pivotal movement of a first section of the ramp platform in respect of a second section causes rotation of the pivot bar which, in turn changes the orientation of the lever in respect of the spring.

Preferably, the mechanism further comprises a motor drive control which acts to turn off the drive motor when the first platform section is orientated approximately 20 degrees from horizontal, bearing in mind that the floor of the second section is angled at approximately 12 degrees.

### BRIEF DESCRIPTION OF THE DRAWINGS

The invention will now be described by way of example only with reference to the accompanying diagrammatic drawings, in which:—

FIG. 1 illustrates a bariatric ramp with a ramp deployment mechanism constructed in accordance with the invention;

FIG. 2 is an exploded view of the mechanism;

FIGS. 3 and 4 illustrate the deployment mechanism in use;

FIG. 5 is an exploded view of an alternative tension spring mechanism suitable for use with the invention; and

FIGS. 6 to 10 are exploded views of a torsion spring mechanism suitable for use with the invention.

### DETAILED DESCRIPTION OF THE INVENTION

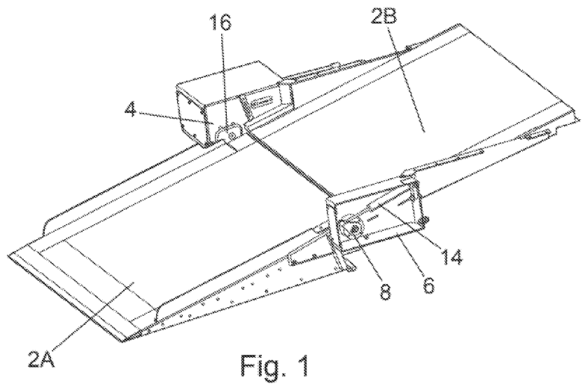

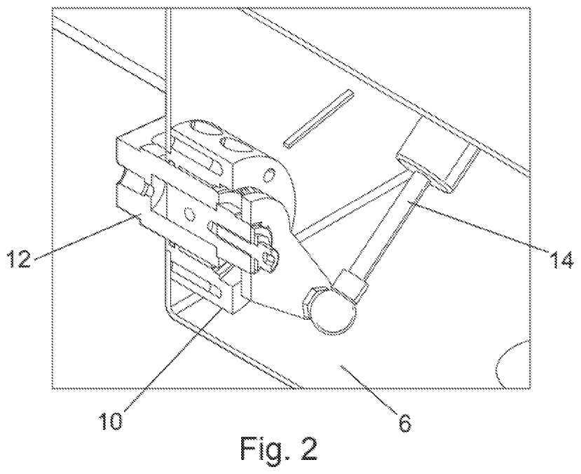

FIG. 1 shows a non-conventional sized bariatric ramp with an improved ramp deployment mechanism suitable for the additional weight of the ramp system 2.

The ramp system 2 includes a platform section 2A tiltable with respect to pan section 2B. Pan 2B includes housing 4 in which is housed a geared motor (not shown). Platform 2A is pivotally secured to housing 4 and extends across pan 2B.

On the other side of ramp pan 2B, opposite the motor housing 4, is a further housing 6 in which is located a lever 8 secured at one end to a bearing housing 10 through which is connected a pivot bar 12 providing the mechanism to raise the platform 2A. The other end of the lever 8 is attached to a traction gas spring 14 secured within the lever housing 6.

The lever 8 is positioned opposite the pivot point 16 of the drive motor.

The gas spring 14 is hard wearing and heavy duty and, in use, acts to assist the drive motor, or the operator during manual deployment, to stow or deploy the ramp platform 2A.

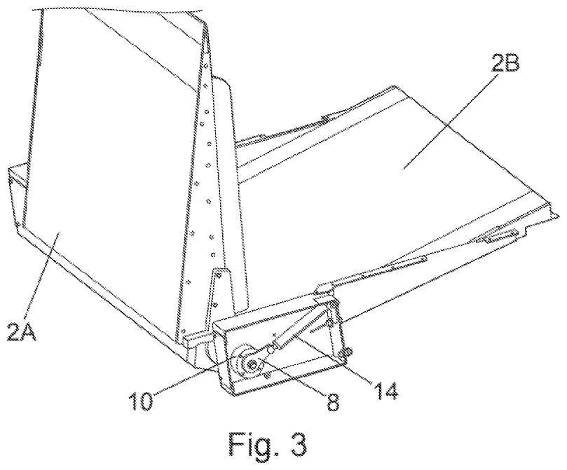

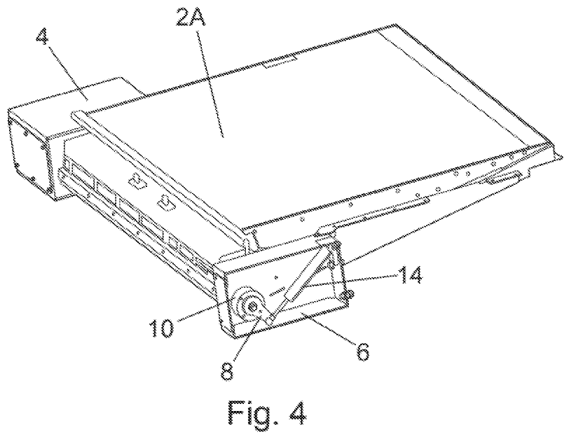

To this end, and as can be seen in FIGS. 3 and 4, as the platform 2A lifts and tilts in respect of the pan 2B, the pivot bar 12 rotates causing the lever 8 to orientate towards the spring 14 which then provides a controlled pulling force to assist continued raising of the platform 2A.

Conversely, once the platform 2A passes the top dead centre, continued rotation of the pivot bar 12 causes the lever 8 to orientate away from the spring 14 which then acts to counteract the torque generated by the platform 2A as it lowers towards its end, stowed, position. When platform 2A closed, the process described above is reversed.

By reducing the torque required from the drive motor to lift the platform 2A, a smaller sized power drive motor can be used. In the case of manual deployment, the required force is reduced to a level associated with conventional ramps.

Once the platform 2A reaches approximately 20 degrees from its fully open or fully closed orientation, a drive controller (not shown) acts to turn the drive motor off at which time the platform 2A continues to lower under gravity to drive the motor, acting then as a generator.

The controller includes a resistor though which generated electricity is routed. The resistor causes a resistance to the drive motor rotational movement thereby slowing the motor and the movement of the platform 2A. Consequently, movement of the platform 2A decelerates as it reaches its fully closed or fully open orientation ensuring that the platform 2A does not slam open or closed.

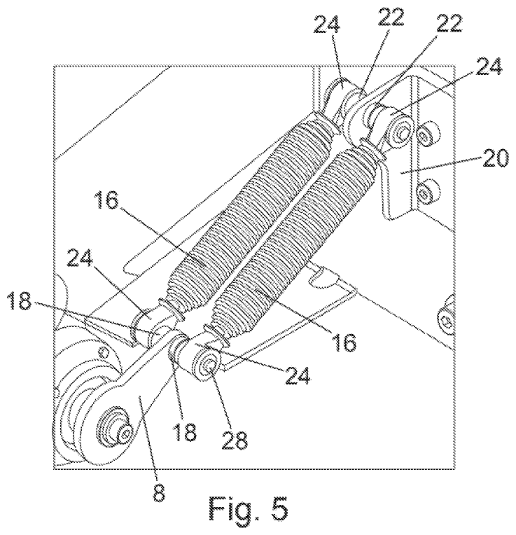

FIG. 5 is an exploded view illustrating an alternative spring mechanism of the invention.

In this embodiment, two tension springs 16 are used orientated side-by-side to provide the required strength and extension range required for the deployment mechanism.

To this end, the lever 8 has side extensions 18 on opposing surfaces each to receive the end of a respective spring 16. The other end of the springs 16 are secure to a bracket 20 secured to the housing 6 which has similar opposing side extensions 22.

Each side extension 18, 22 provides a shaft and each end of both springs 16 has an end connector 24 which extends around the side extension 18, 22 to be rotatable about its shaft. The connector 24 is then held on the shaft by a retaining circlip and washer 28.

To provide a smooth rotation and reduce friction, each connector 24 includes a polymer sleeve bearing.

The single spring as described in the first embodiment may also incorporate an end connector as described.

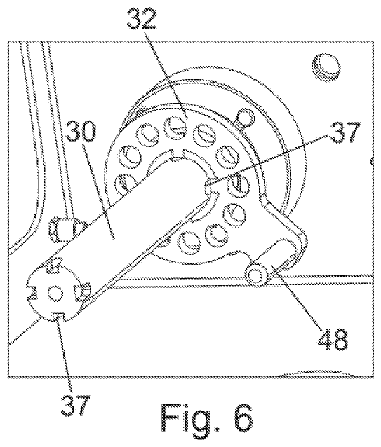

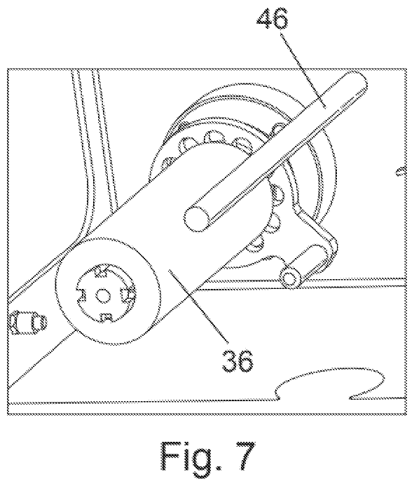

FIGS. 6 to 10 are exploded views illustrating the working of a torsion spring as an alternative spring mechanism for use with the invention.

The mechanism includes a drive shaft 30 at either end of which are located a torque lever 32, 34. A nylon cover 36 surrounds the drive shaft 30.

Each torque lever 32, 34 includes an array of tabs which locate within complimentary keyway slots 37 formed in either end of the drive shaft 30. One slot and tab of each set located at either end of the drive shaft 30 has a wider dimension to ensure correct orientation of the torque levers 32, 34.

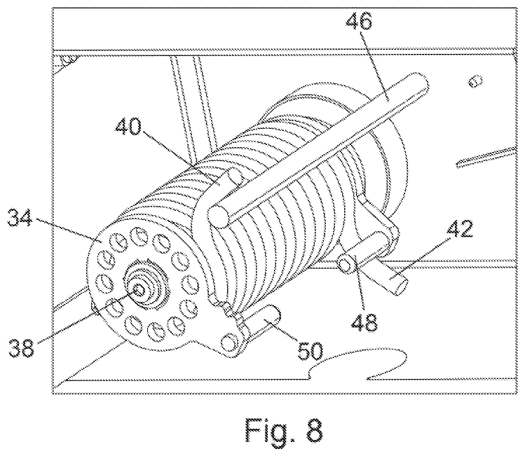

FIG. 8 shows the fully constructed spring assembly. A nylon spacer is retained on the shaft 30 and extends to the first torque lever 32 to clamp the first lever 32 in place.

An M8 screw, Belleville washer and M8 repair washer 38 are secured over the distal end of the drive shaft 30 to secure the second torque lever 34.

A spring 40 is spiraled around the drive shaft 30 its end forming straightened inner and outer legs 42, 44 respectively.

FIGS. 8, 9 and 10 show the orientations of the components of the spring mechanism as the platform 2A is moves from closed position to an open position.

FIG. 8 shows the spring mechanism when the platform 2A is in a closed position. Here the outer leg 44 of the spring 40 abuts a fixed bar 46 extending from the housing parallel to the drive shaft 30. The gap between the fixed bar 46 and the drive shaft 30 is sufficient to allow each lever 32, 34 to pass underneath during rotation of the drive shaft 30 but to prevent the inner and outer legs 44, 42 of the spring 40 from passing under.

At the same time, the inner leg 42 abuts an inwardly protruding extension 48 of the first torque lever 32. The first lever remains active between the platform 2A being fully closed and the platform 2A is top dead centre.

The second torque lever 34 however is not active during this time, its inwardly protruding extension 50 having no contact with the outer leg 44 of the spring 40.

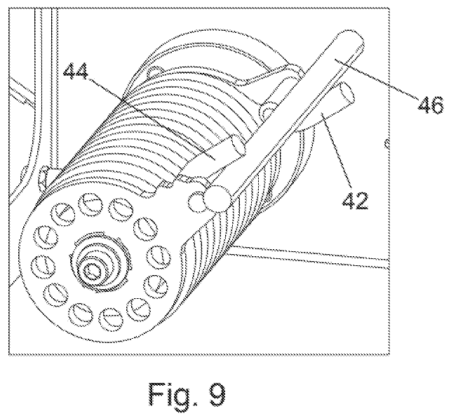

FIG. 9 shows the spring mechanism when the platform 2A is at top dead centre (shown for example in FIG. 3). Rotation of the drive shaft 30 causes the extension 48 of the first torque lever 32 to move anti-clockwise beyond the fixed bar 46 causing the inner leg 42 of the spring 40 to abut the fixed bar 46 and no longer engage the extension 48 of the first torque lever 32.

The outer leg 44 of the spring 40 remains engaged with the other end of the fixed bar 46 so not in engage with the second torque lever 34. The torsion spring 30 is, at this time, in its most relaxed position having no engagement with either torque lever 32, 34.

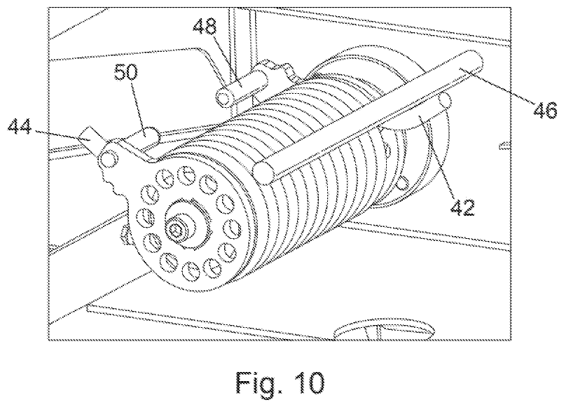

FIG. 10 shows the final position of the spring mechanism with the platform 2A is fully open. Here, the inner leg 42 of the spring 40 remains in abutment with the fixed bar 46 having no engagement with the first torque lever 32 (which has continued to rotate anti-clockwise moving further away from the bar 46).

The second torque lever 34, on the other hand, rotates anti-clockwise under and beyond the fixed bar 46 for the extension 50 to abut and engage with the outer leg 44 of the spring 40. Whilst the first torque lever 32 is no active, the second torque lever 34 remains active whilst the platform 2A moves between top dead centre and fully open position.

As the platform 2A is closed the spring mechanism works in reverse with the spring rotating clockwise through positions where the first torque lever 32 is not active and the second torque lever 34 is, to the position where both torque levers 32, 34 are not active, and finally to a position where the first torque lever 32 is active and the second torque lever 34 is not.

1. A deployment mechanism for a bariatric ramp having a drive motor pivotally secured to one side of the ramp platform, the deployment mechanism including a lever located in a housing on the opposing side of the platform ramp, one end of the lever being connected to a platform pivot bar and the other end being connected to a torsion spring mechanism secured within the housing; wherein the spring mechanism comprises a drive shaft having a first and second torque levers located either end of the drive shaft, the drive shaft being rotatable as the platform is deployed such that the torque levers move between a first position whereby only the first torque lever acts on the spring and to a second position whereby neither first nor second torque levers act on the spring and to a third position whereby only the second torque lever acts on the spring.

2. The mechanism according to claim 1, wherein the drive shaft includes a spring with inner and outer straightened legs and respective ends of the spring.

3. The mechanism according to claim 1, wherein the spring mechanism further comprises a fixed bar secured at one end to housing and extending generally parallel to the drive shaft.

4. The mechanism according to claim 3, wherein a gap is provided between the drive shaft and the fixed bar which is sufficient to allow each torque lever to pass underneath during rotation of the drive shaft.

5. The mechanism according to claim 4, whereby each spring leg extends outwardly from the spring coil beyond the gap between the fixed bar and the drive shaft.

6. The mechanism according to claim 5, whereby activation of a torque lever is enabled when a leg of the spring abuts against the fixed bar.
